(19) United States
(12) Patent Application Publication
(10) Pub. No.: US 2004/0005141 A1
(43) Pub. Date: Jan. 8, 2004

(54) Data logging and digital video recording/playback system

(76) Inventor: Robert G. Combs, Plano, TX (US)

Correspondence Address: BROWN & MICHAELS, PC, 400 M & T BANK BUILDING, 118 NORTH TIOGA ST, ITHACA, NY, 14850, US

(21) Appl. No.: 10/603,443

(22) Filed: Jun. 25, 2003

Related U.S. Application Data
(60) Provisional application No. 60/391,491, filed on Jun. 25, 2002.

(51) Int. Cl. H04N 5/783

(52) U.S. Cl. 386/69; 386/70

(57) ABSTRACT

A system for collecting, storing, and reviewing data related to events occurring under the direction of an automated controller includes a digital signal capture card for sensing and collecting discrete digital signals, a multi-port serial port expansion card for sensing and collecting serial digital communication messages, a video frame grabber and compression card for sensing and collecting video signals, a device for indexing and storing the digital and video signals, and for relating occurrence of a particular item of a particular data type, whether digital, serial or video, to the most closely time-related data item from the other data types, and a display for control of the system and presentation of recorded data to a user during review.

### REFERENCE TO RELATED APPLICATIONS

This application claims an invention, which was disclosed in Provisional Application No. 60/391,491, filed Jun. 25, 2002, entitled “DATA LOGGING AND DIGITAL VIDEO RECORDING/PLAYBACK SYSTEM”. The benefit under 35 U.S.C. § 119 (e) of the United States provisional application is hereby claimed, and the aforementioned application is hereby incorporated herein by reference in its entirety.

### BACKGROUND OF THE INVENTION

1. Field of the Invention

The invention pertains to the field of data collection and logging systems. More particularly, the invention pertains to a system with improved means for capturing and evaluating data and associated environmental imagery.

2. Description of Related Art

In the testing and verification of automated systems and computer-based controllers, it often is desirable to monitor and record inputs to a controller and observe the controller's outputs in response to the inputs. It is common for systems and controllers to have several forms of informational inputs and outputs (I/O), most commonly including digital data and serial digital messages. For example, some samples of such data are:

Digital Data: Basic sensors indicating an on/off, conditional pass/fail, true/false, or presence/no-presence detection.

Serial Digital Data: Data messages from computer or microprocessor-based sensors and peripherals that indicate various measured or detected values, as well as sensor status. These typically are transmitted via standard data transmission protocols, such as RS232/422.

In addition to the data collected, it often is desirable to have a visual record of the system during the test period. A visual record, such as that provided by a video recorder, can provide vital information that puts the logged data into context. The video record provides an ability to understand conditions of the test that are not anticipated, not under the control of the testing organization, or exhibit behaviors or parameters that are not readily instrumented.

Previous approaches involved incorporating several stand-alone data collection components, typically including an oscilloscope or logic analyzer to capture the digital data, a protocol analyzer or separate computer for serial data collection, and video recording equipment, such as a VCR, to record physical events and environmental conditions during the testing. However, the methods known in the prior art have several drawbacks. Generally, the equipment is large, cumbersome, and difficult to connect and prepare. The control of each device normally must be managed individually, thus requiring excessive time and inviting mistakes during the recording process. Another shortcoming is encountered during review and analysis of the data. The data cannot be readily reviewed with a common time context; the data cannot be readily analyzed in such a way that the data from one source is presented within the context of the other data sources.

Takase in U.S. Pat. No. 6,381,501 (2002) describes a data logging system utilizing one or more programmable logic controllers (PLC) to collect data and forward them to a centralized factory automation controller (FAC). However, this solution does not address the incorporation of collect serial digital data from “intelligent” sensors and subsystems, nor the ability to collect digital video, nor a means to present the multiple forms of data such that the time correlation between the data elements is apparent to the user.

There have been multiple variations of recording video and associated serial digital data by utilizing a video character generator to provide a composite video image, in which the data are superimposed on the surveillance images. See, for example, U.S. Pat. No. 4,337,482 to Coutta, and U.S. Pat. No. 4,630,110 to Cotton. However, these approaches address only the ability to record textual based serial digital data, and do not provide the ability to evaluate the recorded text as data. Rather, by converting the data to textual images before recording, the data are no longer digital data that can be utilized by a computer during playback and review.

U.S. Pat. No. 5,920,338 to Katz improves on the textual overlay approach, referenced in the paragraph above, with a technique that stores the serial digital data separately from the video images. A synchronizing signal embedded in the data is utilized to correlate the digital data with the video imagery. This is an improvement in that the digital data are maintained in digital format, allowing greater flexibility during playback and review. However, the Katz approach requires that each data item support the synchronization scheme for data correlation, through a time-tag or other such indexing value attached to each data item. This is not compatible for a test system, where it is not desirable to modify the system under test to support a particular indexing scheme. This also is problematic with discrete digital information that, by definition, can only posses binary state information (on/off) and could not incorporate additional synchronization information.

### SUMMARY OF THE INVENTION

The present invention provides an improved data logging system, which preferably is hosted on a centralized PC computer equipped with data collection hardware and application software to allow the capture, recording, and playback of discrete digital data, serial digital data, and video images. The collected data and video are indexed by a software process, preferably on the logging computer, allowing time-synchronization of the data items without support from the device(s) under test. The data items preferably are stored on the computer hard drive, allowing rapid access to all data by a single playback application for display and analysis.

Briefly stated, a system for collecting, storing, and reviewing data related to events occurring under the direction of an automated controller, includes a digital signal capture card for sensing and collecting discrete digital signals, a multi-port serial port expansion card for sensing and collecting serial digital communication messages, a video frame grabber and compression card for sensing and collecting video signals, a device for indexing and storing the digital and video signals, and for relating occurrence of a particular item of a particular data type, whether digital, serial or video, to the most closely time-related data item from the other data types, and a display for control of the system and presentation of recorded data to a user during review.

In a preferred embodiment, each data item is indexed to allow time correlation to any of the other data items. This allows for synchronous playback of the recorded data, the ability to have any one data source queue the other sources. The data items are synchronized in a “best fit” fashion, where the data items from the non-controlling sources are driven to the closest time of the data item currently under the control of the user. This system can be sized according to I/O and storage capacity requirements.

In a preferred embodiment, the review of data is enhanced by having the data from all sources readily available in a format that allows for immediate retrieval by the review application. The data are available for rapid retrieval allowing for near instantaneous access of data from any recorded period. The entire period of recorded data can be searched to look for particular events, sequence of events, or combination of events from multiple data sources.

### BRIEF DESCRIPTION OF THE DRAWING

FIG. 1 shows a schematic block diagram of the data collection and logging system of the present invention. A typical controller with peripheral sensors and subsystems is included on the left of the diagram. The data paths between the controller and its peripheral devices are tapped and routed to the data logging system to allow signal and data capture.

FIG. 2 shows a hardware block diagram summarizing the major components of the data logging system of the present invention.

FIG. 3 shows a data flow diagram of the logging system of the present invention during data capture and record.

FIG. 4 shows a data flow diagram of the logging system of the present invention during data playback. In this diagram, video frame image data are routed to the video CODEC for decompression and assembly before being sent to the computer video controller.

FIG. 5 shows a data flow diagram of the logging system of the present invention during data playback. In this diagram, video frame image data are decompressed and assembled via the computer's central processor utilizing software algorithms, before being sent to the computer video controller.

FIG. 6 shows a diagram depicting the data logger of the present invention as installed to test a toll collection system. The data logger monitors discrete signals from vehicle presence and axle detection sensors sent to the lane controller. The data logger also monitors the serial communication messages between the lane controller and a Radio Frequency Identification (RFID) tag reading subsystem.

FIG. 7 shows an electrical schematic diagram detailing a typical interconnection for monitoring a discrete signal to/from the system under test using the present invention.

FIG. 8 shows an electrical interconnection diagram detailing methods for monitoring RS232 and RS422 serial communication links.

FIG. 9 shows an image of the playback user interface detailing the display of the video images.

FIG. 10 shows an image of the playback user interface detailing the display of the discrete digital data in strip chart format.

FIG. 11 shows an image of the playback user interface detailing the display of serial digital message data.

FIG. 12 shows an image of the overall playback user interface.

FIG. 13 shows an image of the overall record user interface.

FIG. 14 shows a schematic block diagram of the data collection and logging system including digital data active playback.

FIG. 15 shows a block diagram depicting active playback.

### DETAILED DESCRIPTION OF THE INVENTION

The present invention provides an improved system for the testing and evaluation of complex automated systems. The invention provides a data collection and logging system, which combines the functionality of digital data logger, serial message capture, and video recording onto a single PC computer platform. Data from the multiple data sources is stored locally and indexed to allow playback and analysis of the data in time coherent manner. During playback any source of data can provide indexing information to prompt the retrieval of the associated data from the other sources.

An important distinction between the prior art and the proposed system is the requirement in the prior art that the target system provide data in a format compatible with the recording system. The target system must be designed and developed to support the recording system. This is not appropriate for a test system that is to be applied to multiple systems without modifications on the part of the target system under test to accommodate the data logging system. The present invention provides a system that accommodates various data modes in their original format to/from the target system, and thus can be applied to a wide variety of applications and target systems.

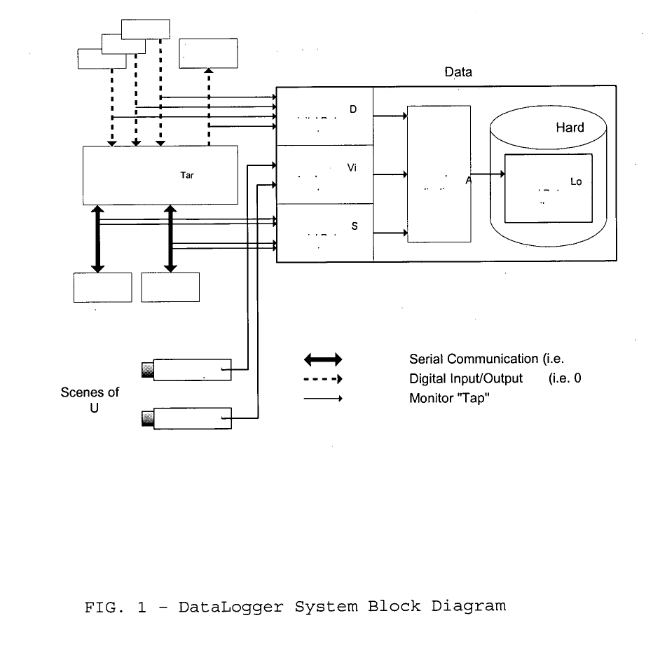

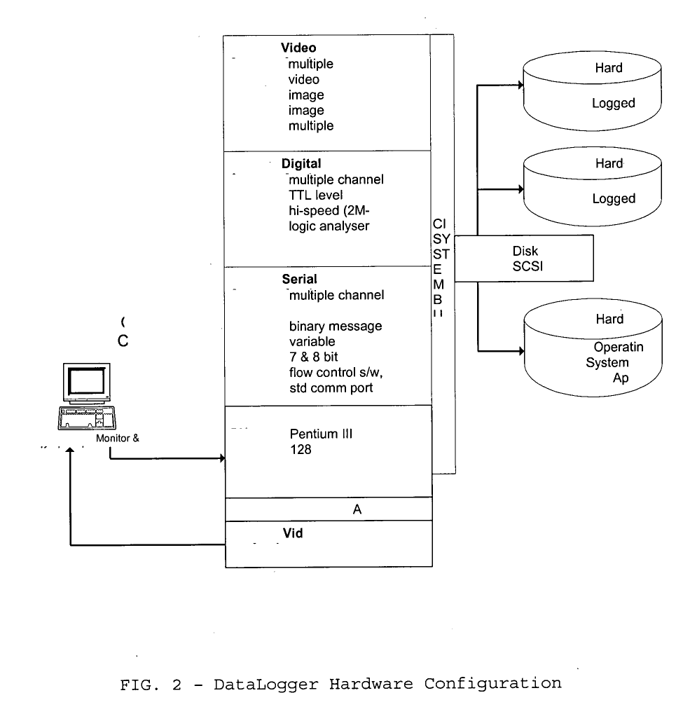

The functional areas of the system are illustrated in FIG. 1. The three data collection blocks seen on the left (Digital Data, Video, and Serial Data Capture) sense, capture, and forward data to the Record Application. The Record Application assembles, formats, and time-tags the captured data and routes them to the appropriate log file. In a preferred embodiment, the system is integrated upon a typical PC platform. The minimum configuration is an Intel Pentium II 233 MHz processor or better, 64 MB memory, Microsoft Windows 2000 operating system, and 20 GB hard drive. Additional hard drive(s) can be added to increase recording storage capacity. In the preferred embodiment, the data sensing and collection functions are performed by the addition of three commercially available expansion boards: Video Capture Card, Digital Capture Card, and Serial Capture Card. FIG. 2 illustrates the PC hardware configuration and the primary functions of the data collection cards. The data capture cards are off-the-shelf items. The video capture card is manufactured by Integral Technologies model Xpress Plus. The discrete digital capture card is manufactured by National Instruments model PCI-DIO-32HS. The serial digital capture card is manufactured by Comtrol model 95880-2. These boards perform the low level functions associated with capturing and conditioning the associated data, considerably reducing the load of the central processor and allowing the selection of a relatively low cost PC platform.

In the preferred embodiment, all data are recorded on the PC hard disk drive. The hard drive capacity is sized according to application requirements. The utilization of disk-based storage provides immediate access to the data without search delays and flexibility in playback direction and speed.

Record Data Flow

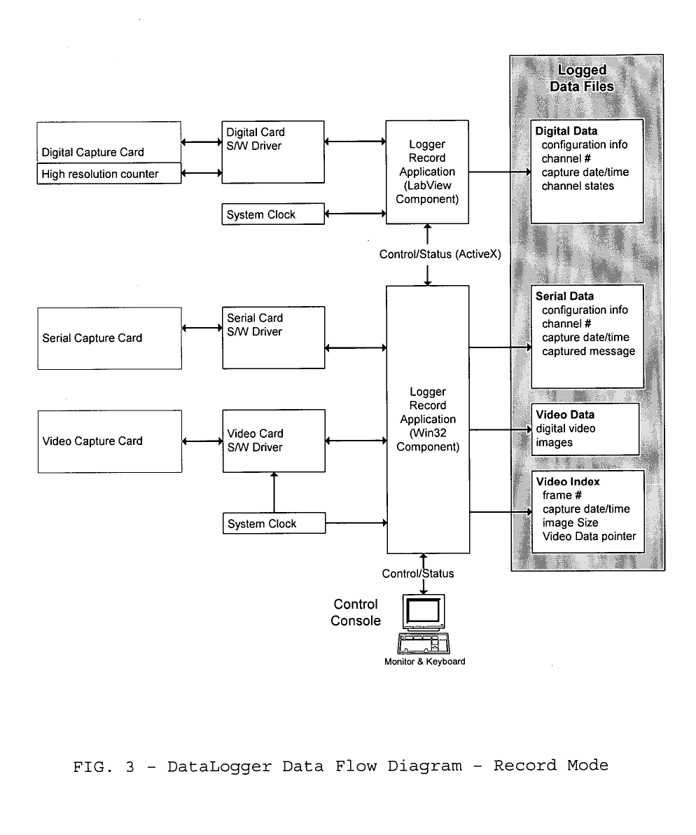

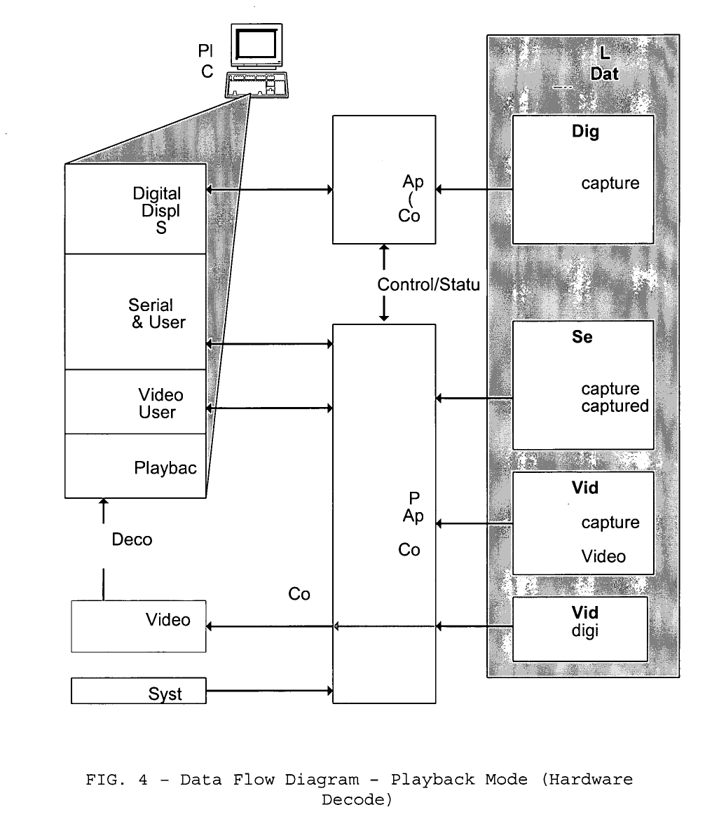

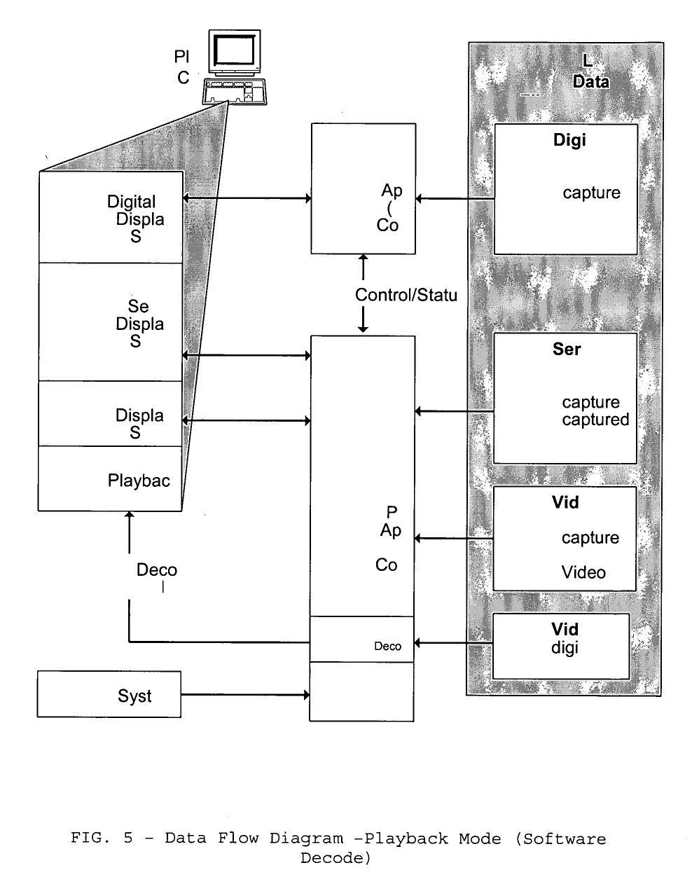

The recording application is segmented into two primary executables, one for the digital data capture and the other for the video and serial. The digital data segment performs all initialization and control of the digital data collection hardware and provides an interface for user settable parameters and control. An interface between the two program executables allows for coordination and synchronization. The data flow during recording is depicted in FIG. 3.

Video

Video imaging is an element that allows greater insight of the test environment than can be derived from data elements alone. During review, the images help establish the context of the data and often provide an understanding that would otherwise remain elusive. It also provides an alternative means of recording elements that might be difficult or expensive to instrument.

In the preferred embodiment, video data capture utilizes a commercially-available video digitization and compression board with 8 input channels. The board is configured to activate the desired video channel(s) to record. Each channel is configurable according to the frame capture rate and size of the compressed image. When active, the video capture card grabs and digitizes a video frame from the active channel. This digitized image is compressed via Wavelet compression. Wavelet compression operates on single images and provides higher image quality and fewer compression artifacts compared to other static capture methods.

In the preferred embodiment, the system will record up to 8 channels of video, B&W and/or Color, and supports NTSC and PAL video formats. Cameras are most often trained on the area or subsystem under test; however, a camera can also be set to record the image and data from other test equipment, such as an oscilloscope. The user is able to adjust the frame capture rate and the level of compression of the recorded video. This allows optimization of image quality and time between video frames against storage requirements.

The record application builds two files associated with the video images: a video image file containing sequential compressed digital images, and an index file containing source channel, time-tag, and pointer into the video image file.

During playback the video can be viewed as normal motion video, or jump and hold to any portion of the recorded period, depending on user inputs, as shown in FIG. 9.

Digital Data

In the preferred embodiment, the data logger incorporates high-speed digital data acquisition to monitor 8 discrete inputs/outputs. The data is sampled at a very high rate (up to at least 100,000 samples per second) providing the ability to detect very small events and high-resolution time calculations. Data compression is utilized allowing the data logger to record at high resolution for hours with a minimum of disk storage space.

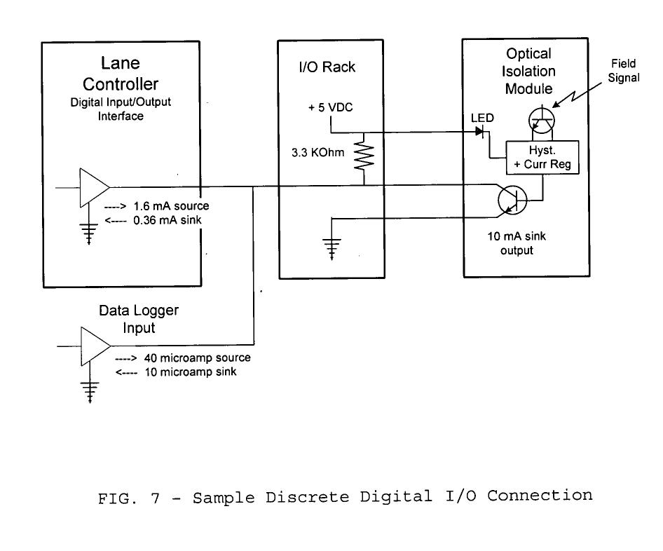

The data logger supports TTL level inputs, which is compatible with most commercial digital I/O components (Opto-22, Grayhill). The most common applications involve tapping into the “computer side” of the digital signal, between the isolation module and the controllers digital I/O components. The data logger inputs are high impedance, 40 μA (microamp), which allows the original signal to be monitored in parallel without affecting the existing equipment. A typical interconnection method is shown in FIG. 7

During system startup, the Record Application configures the digital I/O card. It is set to automatically sample the digital inputs at a fixed rate independently of the recording application. The sampling rate is adjustable by the user up to 100,000 samples per second. The digital I/O card is also configured to automatically buffer the state of any changes, along with a time-tag generated from an on-board high-resolution counter. Upon a change of any monitored input, a sample of each input is captured, along with the count since the start of recording, and the values are stored in an on-board memory array. The system clock is used to obtain the recording starting time, and the value from the on-board counter is used to generate an offset to the start time. The recording periodically (approximately 100 ms) retrieves any data from the on board array, and loads it to an array in local memory. The data are then formatted and saved to a log file on the data hard drive.

The digital data file contains a header and a series of records, one for each state change that occurred during the recording period. Each record contains the time-tag of the state change and the state of the input points at that time. The header contains the recording start and stop date/time and program version.

During recording, the digital data segment provides status feedback to the system operator. The status includes duration of recording, current state of each input point, and the total number of state changes of each input point.

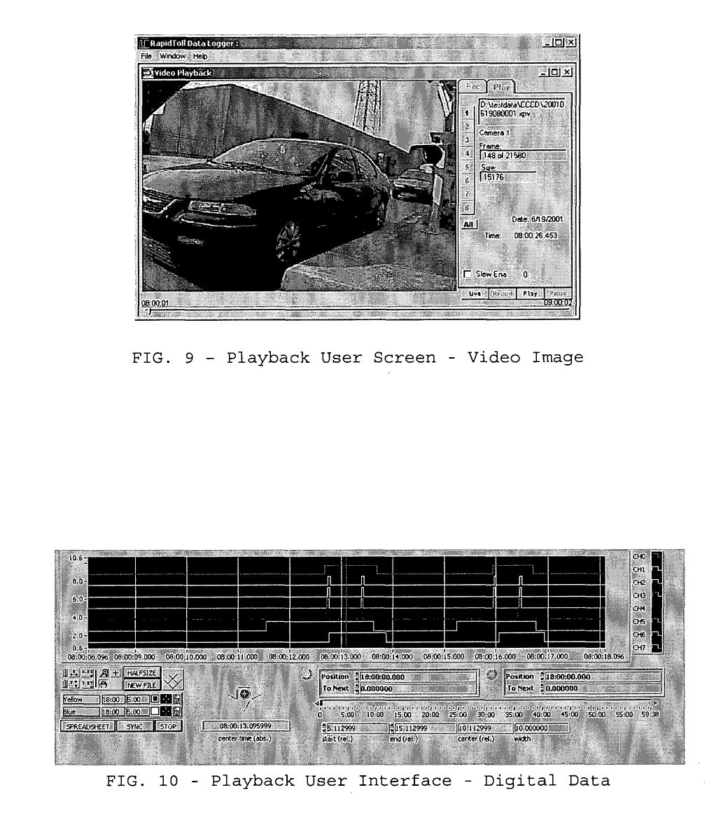

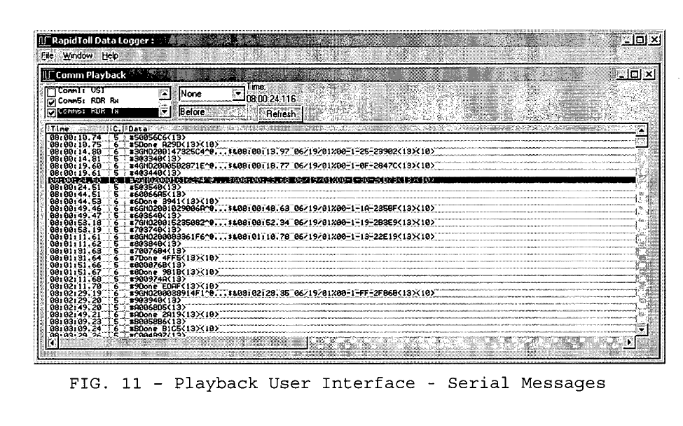

During playback, digital state information is presented in a strip chart format with each monitored I/O point represented by a different color, as shown in FIG. 10. On the strip, chart time is increasing left to right. The current playback time, corresponding to the video and serial playback displays, is in the center of the strip chart and indicated by a red line. The state of each signal can be determined by the level change of the specific channel. Cursor tools are available to assist in timing analysis. In addition, the logged digital data can be imported into a spreadsheet or database for additional analysis.

Serial Data

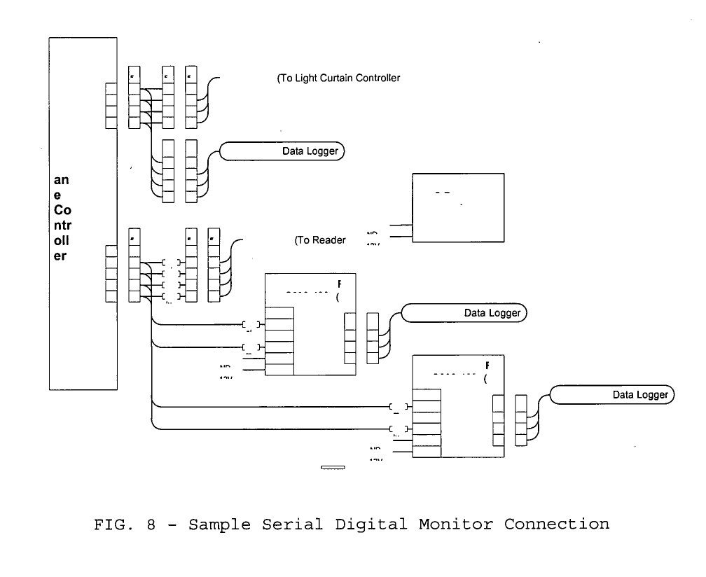

In the preferred embodiment, the data logger is equipped with multiple serial communication ports to provide monitoring and recording of serial (RS-232/422) messages between subsystems. Additional serial channels can be provided if required. Typically, two logger channels are allocated for each serial connection, one for each transmitter. The logger can then monitor and record message traffic in each direction without disruption. A typical interconnection method is shown in FIG. 8.

In the preferred embodiment, serial data capture utilizes a commercially-available serial expansion board and is controlled by the record application. Each port is configured to ignore flow control and provide raw data bytes to the application. This is necessary to accommodate occurrences nulls and control characters that can occur with devices that utilize binary or “non-ASCII” communication protocols. Raw data bytes are provided to the record application as they are received.

Each port is also configured to match the data transmission settings of the device being monitored on that particular channel: baud rate, data bits, stop bit, or parity. The user for each application configures these. The port is also configured according to the protocol and/or message format utilized by the device being monitored. The record application logs complete messages, as opposed to individual bytes as they are received. To accomplish this, the recording channel is configured according to the various protocol parameters utilized in asynchronous serial communications. Common methods for identifying message completion are an EOT byte/character common in ASCII-based protocols, SOM byte/character with a byte length or record count value in the message header, and fixed length messages. The user can also select if the captured data is to be stored in hex or ASCII format.

The invention is not limited to monitoring only previously known transmission protocols and message formats. By design, the system can be configured by the user to adapt to new interfaces that are encountered. The system is highly flexible in its ability to support both ASCII and binary based messaging schemes for fixed and variable message lengths. Each serial port is configurable in terms of hardware settings (i.e., baud rate, data bits, parity, stop bits) and data protocol.

When the port is active, received data bytes are buffered until the end of message is determined, at which time a time-tag is assigned to the message and it is displayed on the user communication monitor for that channel. If recording is active, the message is also written to the serial data file. The serial message records contain the source channel, time-tag, and captured data.

Once captured, the serial data are stored along with channel source and time-tag information. Recorded serial messages from one or more channels can be exported into text files for import into a spreadsheet or database for analysis.

### OPERATION

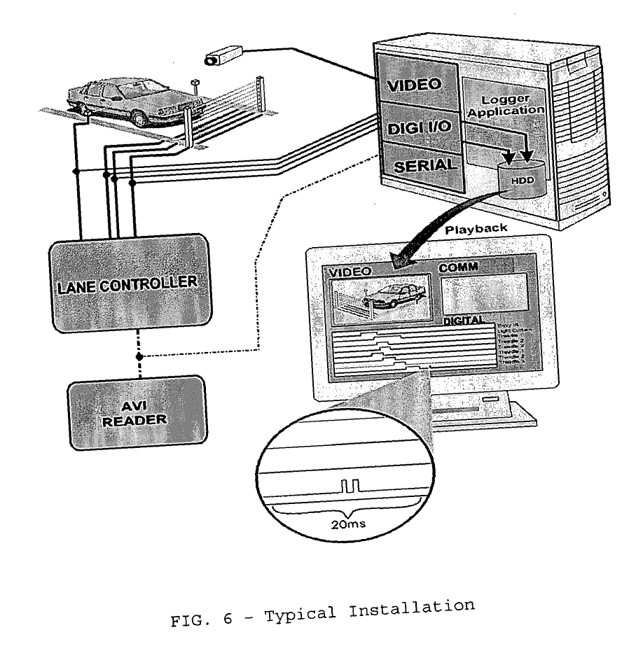

FIG. 6 depicts an embodiment of the data logger of the present invention, configured for testing a lane control system in a toll collection lane, in this instance, monitoring the Automatic Vehicle Classification (AVC) and Automatic Vehicle Identification (AVI) Reader in the test lane. A single camera is situated to obtain a view of the vehicle as it passes thought the AVC components. The signals from the AVC components, a light curtain, treadle, and discrete point detector, are tapped into and sent to the logger's Digital I/O section. Serial communication between the AVI Reader and Lane Controller are routed to two channels of the serial expansion card (Tx & Rx).

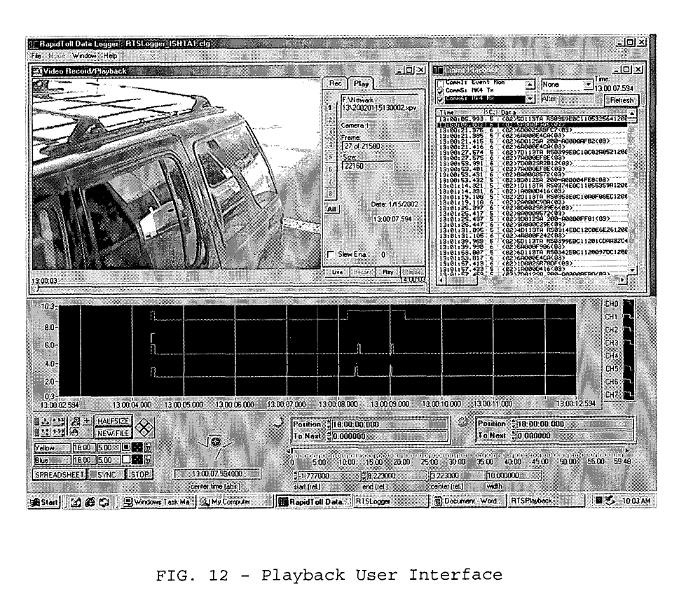

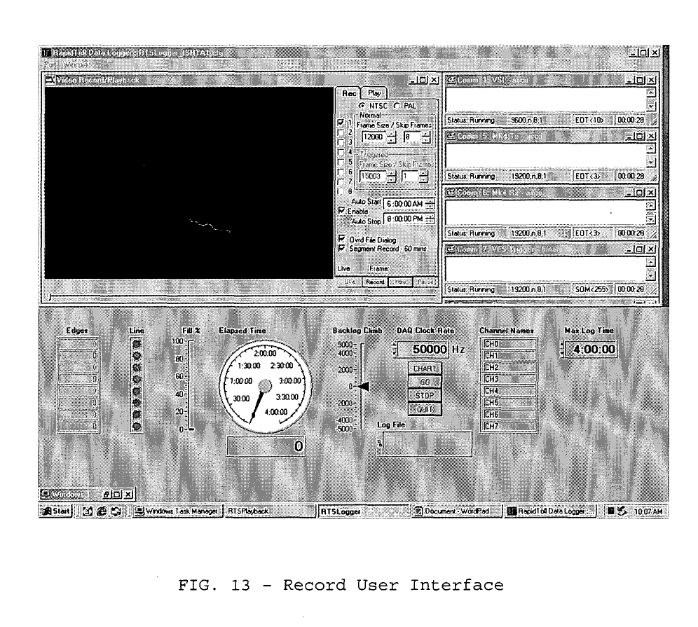

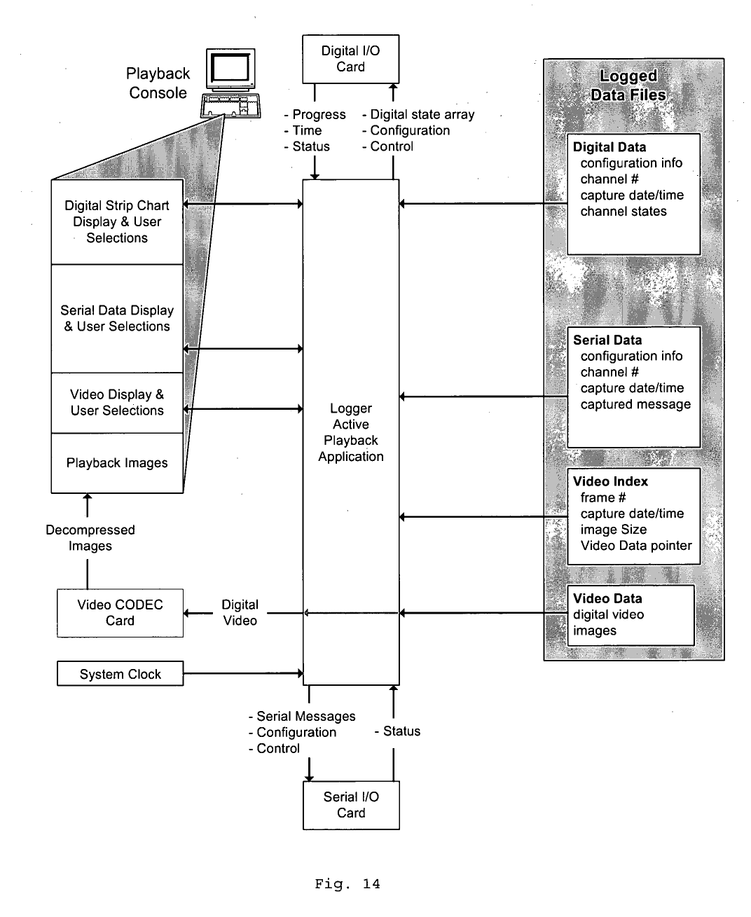

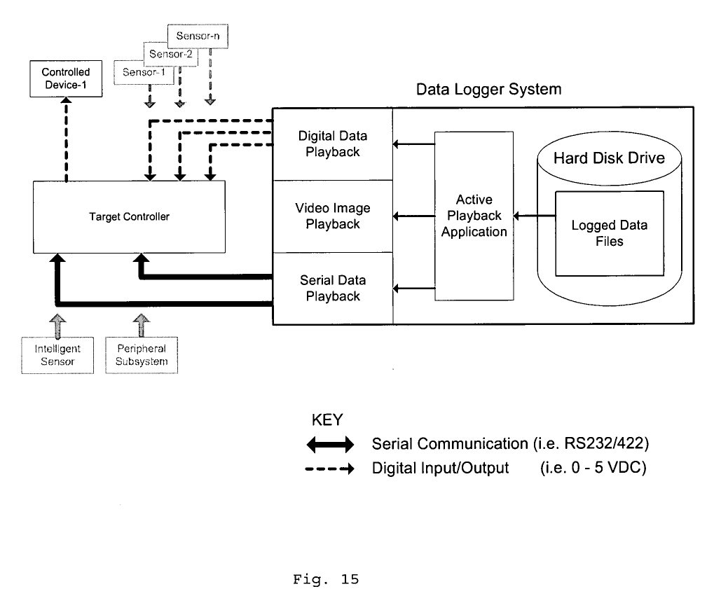

During playback, the data are presented in a synchronous fashion, similar to a time-lapse VCR with associated data displays. As shown in FIG. 12, the main data types (video, digital, serial) are separated into three separate display windows. The user controls and makes selections within the three windows primarily with mouse commands. The system automatically directs the focus of the playback timing according to the window, and subsequent data type, that the user is currently operating on. The other windows are automatically directed to slew their playback time values according to the time established by the primary window. The effect from the point of view of the user is similar to having a video recorder, logic analyzer, and protocol analyzer operating in a synchronized fashion.

Active Playback

Active Playback function allows the recorded data to be regenerated during playback providing the ability for the data logging system to simulate the recorded data. In the preferred embodiment, recorded data, both serial messages and discrete digital data, are presented to the user via graphical interface during playback. With active playback, in addition to the graphical display, the serial messages are sent out of serial communication ports and the digital signals are asserted via the Digital Input/Output card.

During active playback the data logging system outputs are connected to the inputs of the system under test. The signals are then regenerated to the system under test with the same format and timing as the original recording, such that recorded video is routed to a monitor or other suitable device for viewing video. The target systems response to these inputs can then be studied and evaluated. Data sequences that cause the target system trouble can be repeated until the root cause is understood. Once a correction to the target system is implemented the troublesome data set can be played back again to confirm that the target system can now correctly manage the scenario.

This enhancement is accomplished with software modifications only and runs on the original hardware configuration. The wiring interconnections are different. During recording the data logging system is connected to monitor the inputs to the system under test. During active playback the data logging system outputs are connected to the inputs of the system under test, replacing the signals from the original sensor(s) and subsystems(s).

Another variation is to generate the playback files from a utility program to allow simulation of sensor configurations that do not exist or have not been made available to recording. It also allows a “what if” capability to simulate conditions of various timing that have not been recorded.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for collecting, storing, and reviewing data related to events occurring under the direction of an automated controller, comprising:
a) a digital signal capture card for sensing and collecting discrete digital signals;
b) a multi-port serial port expansion card for sensing and collecting serial digital communication messages;
c) a video frame grabber and compression card for sensing and collecting video signals;
d) means for indexing and storing said digital and video signals;
e) means for relating occurrence of a particular item of a particular data type, whether digital, serial or video, to the most closely time-related data item from the other said data types; and
f) a display for control of said system and presentation of recorded data to a user during review.

2. The system of claim 1, wherein reviewed discrete digital data are presented in graphical strip chart format.

3. The system of claim 1, wherein reviewed video data are presented in picture format of still image or time-motion video images.

4. The system of claim 1, wherein reviewed serial communication data are presented in time-ordered message sequence.

5. The system of claim 1, wherein reviewed serial communication data are presented as recorded in hexadecimal or ASCII format.

6. The system of claim 1, wherein reviewed serial communication data are translated according to message parsing rules.

7. A system for collecting, storing, and reviewing data related to events occurring under the direction of an automated controller, comprising a display for displaying said data, operatively connected to:
a) means for sensing and collecting discrete digital signals;
b) means for indexing and storing said digital signals;
c) means for sensing and collecting serial digital communication messages;
d) means for indexing and storing said serial messages;
e) means for sensing and collecting video signals;
f) means for indexing and storing said video signals; and
h) means for relating occurrence of a particular item of a particular data type, whether digital, serial or video, to the most closely time-related data item from the other said data types, retrieving and displaying said time-related data items, according to data the type and data item directed by a user,
wherein said display displays each data type, whether digital, serial or video, in a time-synchronized manner, and
wherein said user directs a displayed time of any individual data type, whether digital, serial or video, and the remaining two data types are automatically moved to a newly directed time.

8. The system of claim 7, wherein reviewed discrete digital data are presented in graphical strip chart format.

9. The system of claim 7, wherein reviewed video data are presented in picture format of still image or time-motion video images.

10. The system of claim 7, wherein reviewed serial communication data are presented in time-ordered message sequence.

11. The system of claim 7, wherein reviewed serial communication data are presented as recorded in hexadecimal or ASCII format.

12. The system of claim 7, wherein reviewed serial communication data are translated according to message parsing rules.

13. The system of claim 1, wherein one or more of said serial digital communication messages are transmitted via serial communication port and wherein said digital signals are asserted via a digital input/output card.

14. The system of claim 13, wherein recorded video is output for viewing.
